(19) United States
(12) Patent Application Publication
(10) Pub. No.: US 2025/0133103 A1
(43) Pub. Date: Apr. 24, 2025

(54) SECURITY VULNERABILITY TRACKING AND RESOLUTION

(71) Applicant: Capital One Services, LLC, McLean, VA (US)

(72) Inventor: Mohamed SECK, Aubrey, TX (US)

(21) Appl. No.: 18/491,384

(22) Filed: Oct. 20, 2023

(51) Int. Cl. H04L 9/40

(52) U.S. Cl. CPC H04L 63/1433

(57) ABSTRACT

In some implementations, a client device may receive an indication of a set of security vulnerabilities that were detected and may determine a set of tickets to open for the set of security vulnerabilities. The client device may determine a priority and a due date for each ticket in the set of tickets and may transmit, to a ticket system, a command to open the set of tickets including the priority and the due date for each ticket. The client device may receive an indication that at least one security vulnerability, in the set of security vulnerabilities, has been resolved and may transmit, to the ticket system, a command to close at least one ticket, in the set of tickets, corresponding to the at least one security vulnerability.

### BACKGROUND

Security vulnerabilities may arise when cloud-based applications are due for security patches or other software updates. Similarly, vulnerabilities may arise when cloud-based images (that may, for example, be used to create cloud instances) are not refreshed (e.g., by having instances based on those images rebooted, rehydrated, or otherwise reestablished).

### SUMMARY

Some implementations described herein relate to a system for automatically creating and closing tickets for security vulnerabilities. The system may include one or more memories and one or more processors communicatively coupled to the one or more memories. The one or more processors may be configured to receive an indication of a set of security vulnerabilities that were detected. The one or more processors may be configured to determine a set of tickets to open for the set of security vulnerabilities. The one or more processors may be configured to determine a priority and a due date for each ticket in the set of tickets. The one or more processors may be configured to transmit, to a ticket system, a command to open the set of tickets including the priority and the due date for each ticket. The one or more processors may be configured to receive an indication that at least one security vulnerability, in the set of security vulnerabilities, has been resolved. The one or more processors may be configured to transmit, to the ticket system, a command to close at least one ticket, in the set of tickets, corresponding to the at least one security vulnerability.

Some implementations described herein relate to a method of creating tickets for security vulnerabilities from delimited values. The method may include receiving, from a user device, at least one delimiter-separated values (DSV) file. The method may include parsing, by a client device, the at least one DSV file to determine a plurality of projects indicated in the at least one DSV file. The method may include transmitting, to the user device, instructions for a user interface previewing a set of tickets based on information in the at least one DSV file and associated with the plurality of projects. The method may include receiving, from the user device, a confirmation of the set of tickets. The method may include transmitting, to a ticket system, a command to open the set of tickets in response to the confirmation.

Some implementations described herein relate to a non-transitory computer-readable medium that stores a set of instructions for creating and closing tickets for security vulnerabilities. The set of instructions, when executed by one or more processors of a device, may cause the device to receive an indication of a set of security vulnerabilities that were detected. The set of instructions, when executed by one or more processors of the device, may cause the device to determine a set of tickets to open for the set of security vulnerabilities. The set of instructions, when executed by one or more processors of the device, may cause the device to transmit, to a ticket system, a command to open the set of tickets. The set of instructions, when executed by one or more processors of the device, may cause the device to monitor to determine that at least one security vulnerability, in the set of security vulnerabilities, has been resolved. The set of instructions, when executed by one or more processors of the device, may cause the device to transmit, to the ticket system, a command to close at least one ticket, in the set of tickets, corresponding to the at least one security vulnerability.

### BRIEF DESCRIPTION OF THE DRAWINGS

FIGS. 1A-1C are diagrams of an example implementation relating to security vulnerability tracking and resolution, in accordance with some embodiments of the present disclosure.

FIGS. 2A-2B are diagrams of an example implementation relating to security vulnerability tracking and resolution, in accordance with some embodiments of the present disclosure.

FIGS. 3A-3C are diagrams of example user interfaces relating to security vulnerability tracking and resolution, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of one or more devices of FIG. 4, in accordance with some embodiments of the present disclosure.

FIG. 6 is a flowchart of an example process relating to security vulnerability tracking and resolution, in accordance with some embodiments of the present disclosure.

### DETAILED DESCRIPTION

The following detailed description of example implementations refers to the accompanying drawings. The same reference numbers in different drawings may identify the same or similar elements.

In some cloud environments, application services (ASVs) or other cloud-based applications may exhibit security vulnerabilities. For example, vulnerabilities may arise when the cloud-based applications are due for security patches or other software updates. Similarly, cloud-based applications may experience vulnerabilities when corresponding cloud-based images (used, for example, to create cloud instances) are not periodically refreshed (e.g., by having instances based on those images rebooted, rehydrated, or otherwise reestablished). When cloud-based images are not refreshed, they may be referred to as “stale” and cloud-based applications relying on the images may be more susceptible to cyberattacks. Technical administrators may collect information regarding vulnerabilities associated with ASVs from corresponding cloud environments. However, these administrators may be required to communicate the vulnerabilities to users, who can then authorize security patches (or other software updates) and can refresh the cloud-based images.

Some implementations described herein enable automatic generation of tickets, using a ticket system, based on security vulnerabilities being detected. The ticket system may thus automatically communicate the security vulnerabilities to users and may even indicate suggested remediations for the security vulnerabilities. As a result, the users are more likely to perform remediation, which improves security. Additionally, some implementations described herein enable automatic closing of tickets based on detecting that security vulnerabilities are resolved, which conserves power, processing resources, and network resources that otherwise would have been spent maintaining the tickets even after resolution of the security vulnerabilities.

A backlog of security vulnerabilities may be stored in a comma-separated values (CSV) file (or multiple CSV files). One example ticket system, Jira®, allows for upload of CSV files to generate tickets for a backlog indicated in the CSV files. However, each project in the backlog must be encoded in its own file. As a result, power usage, processing resource consumption, network resource usage, and memory overhead are all increased because a CSV file is further processed into separate CSV files for upload.

Some implementations described herein enable generation of tickets, based on delimiter-separated values (DSV) files, across a plurality of projects. As a result, power, processing resources, network resources, and memory overhead are all conserved that otherwise would have been wasted on separating DSV files by project. Additionally, the ticket system may automatically communicate about a backlog of security vulnerabilities, indicated in the DSV files, to users. As a result, the users are more likely to resolve the backlog of security vulnerabilities, which improves security.

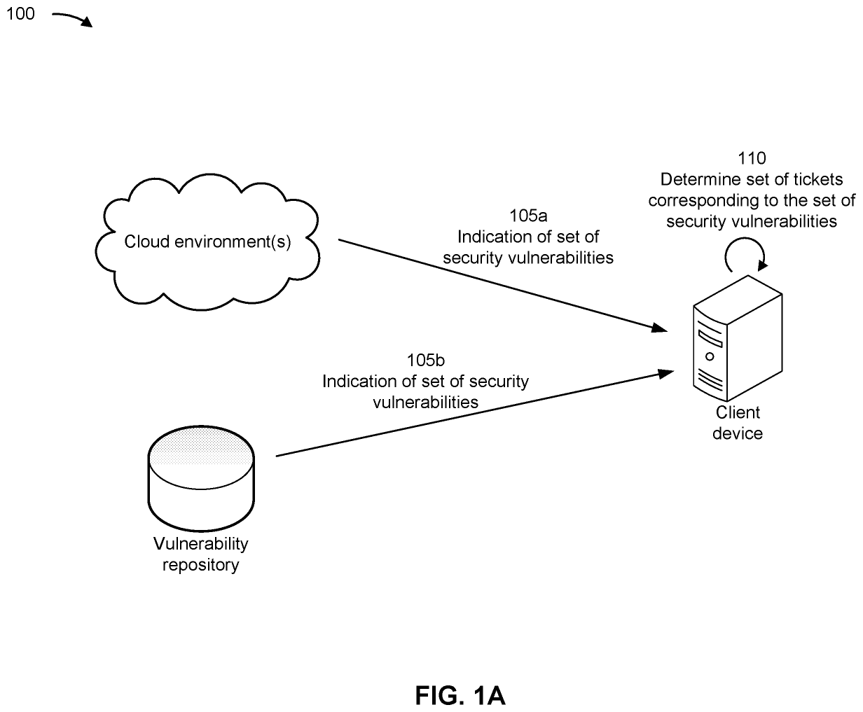

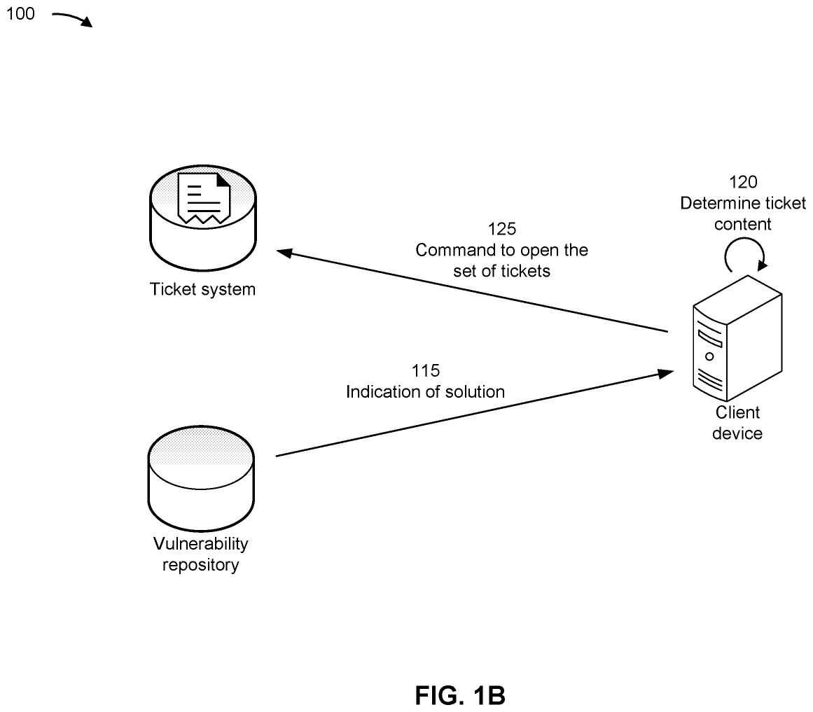

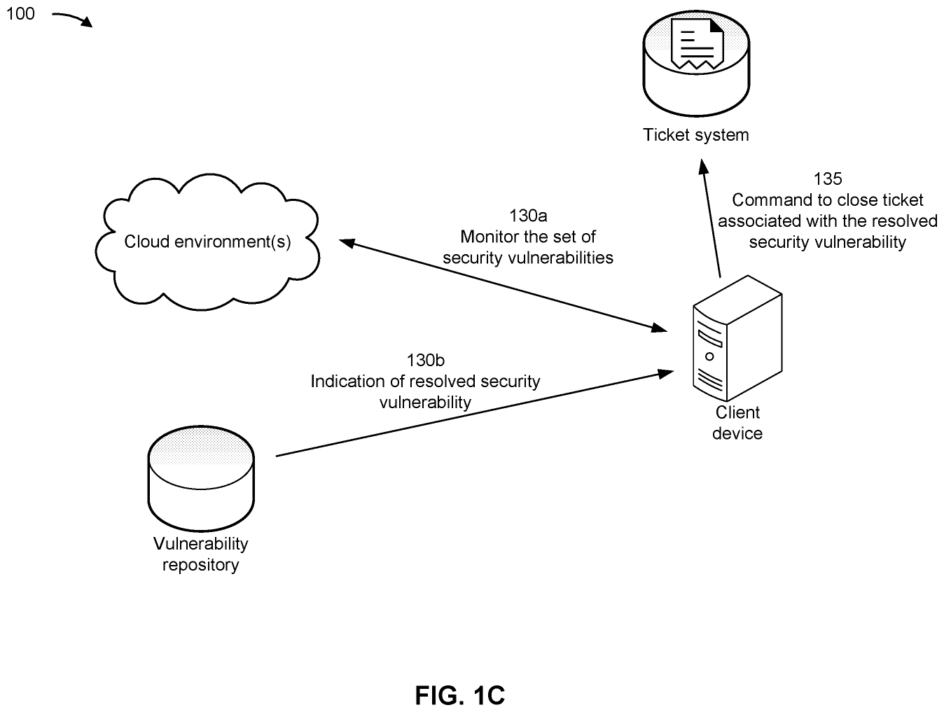

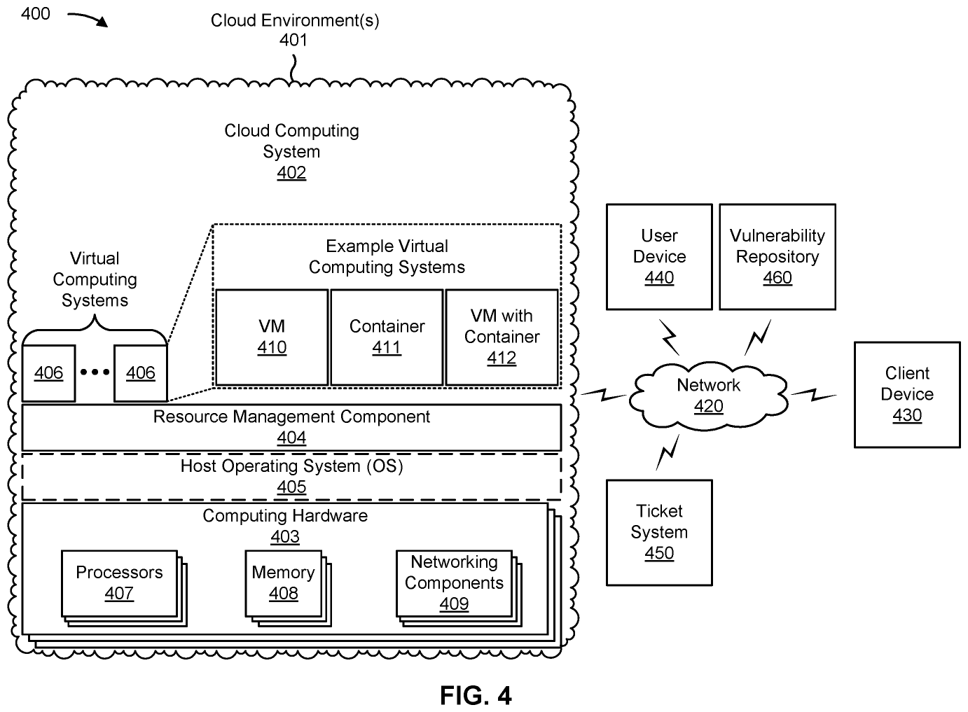

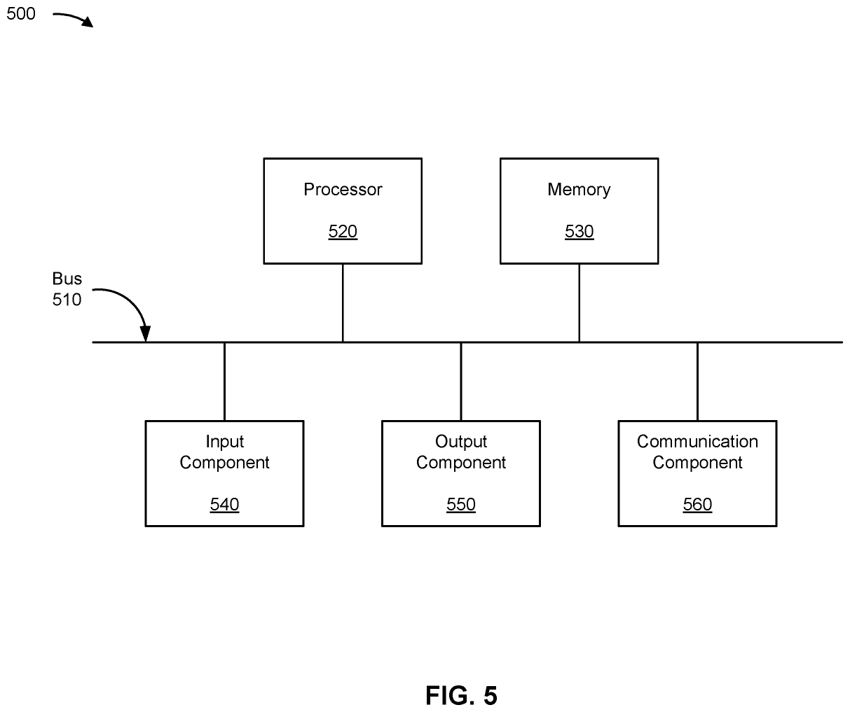

FIGS. 1A-1C are diagrams of an example 100 associated with security vulnerability tracking and resolution. As shown in FIGS. 1A-1C, example 100 includes a client device, a vulnerability repository, one or more cloud environments, and a ticket system. These devices are described in more detail in connection with FIGS. 4 and 5.

As shown in FIG. 1A and by reference number 105a, the cloud environment(s) may transmit, and the client device may receive, an indication of a set of security vulnerabilities that were detected. In some implementations, the indication may include a set of titles corresponding to the set of security vulnerabilities (e.g., a set of strings encoding the set of titles). Additionally, or alternatively, the indication may include a set of priorities corresponding to the set of security vulnerabilities (e.g., based on and/or indicating a set of consequences associated with failure to remediate the set of security vulnerabilities). Additionally, or alternatively, the indication may include a set of titles associated with the set of security vulnerabilities (e.g., each datetime indicating when a corresponding security vulnerability was detected).

In some implementations, the client device may transmit, and the cloud environment(s) may receive, a request for the set of security vulnerabilities. For example, the request may include a hypertext transfer protocol (HTTP) request and/or an application programming interface (API) call, among other examples. The request may include (e.g., in a header and/or as an argument) an indication of a cloud-based application (e.g., one or more indications of one or more cloud-based applications) for which the client device is requesting a list of security vulnerabilities. Accordingly, the cloud environment(s) may transmit the indication in response to the request. The client device may transmit the request according to a schedule (e.g., once per hour or once per day, among other examples) and/or in response to a command to transmit the request. For example, a user device may transmit, and the client device may receive, the command, such that the client device transmits the request in response to the command.

Additionally, or alternatively, the client device may subscribe to security vulnerability updates from the cloud environment(s). Accordingly, the cloud environment(s) may transmit the indication according to a schedule (e.g., once per hour or once per day, among other examples) and/or as available (e.g., shortly after a new security vulnerability is detected).

Additionally, or alternatively, as shown by reference number 105b, the vulnerability repository may transmit, and the client device may receive, an indication of a set of security vulnerabilities that were detected. The vulnerability repository may store information regarding security vulnerabilities. In some implementations, the vulnerability repository may include an on-site database and/or a remote database storing the information. In some implementations, the vulnerability repository may be a relational database, such that security vulnerability indications are stored in association (e.g., via rows and/or columns) with identifiers of cloud-based applications. As another example, the vulnerability repository may be a graph database, such that nodes representing cloud-based applications are connected (e.g., via edges) to nodes representing security vulnerability indications. In some implementations, the vulnerability repository may receive the information automatically (e.g., as output from one or more ASVs) and/or manually (e.g., entered by one or more administrators associated with the cloud-based applications). In some implementations, the security vulnerability indications may indicate a required patch and/or other software update, a missing firewall or other network security software, missing anti-virus and/or other anti-malware software, subpar encryption keys and/or other encryption protocols, out-of-date hardware drivers, and/or other vulnerabilities associated with the cloud-based applications.

In some implementations, the client device may transmit, and the vulnerability repository may receive, a request for the set of security vulnerabilities. For example, the request may include an HTTP request and/or an API call, among other examples. The request may include (e.g., in a header and/or as an argument) an indication of a cloud-based application (e.g., one or more indications of one or more cloud-based applications) for which the client device is requesting a list of security vulnerabilities. Accordingly, the vulnerability repository may transmit the indication in response to the request. The client device may transmit the request according to a schedule (e.g., once per hour or once per day, among other examples) and/or in response to a command to transmit the request. For example, a user device may transmit, and the client device may receive, the command, such that the client device transmits the request in response to the command.

Additionally, or alternatively, the client device may subscribe to security vulnerability updates from the vulnerability repository. Accordingly, the vulnerability repository may transmit the indication according to a schedule (e.g., once per hour or once per day, among other examples) and/or as available (e.g., shortly after a new security vulnerability indication is stored).

Although the example 100 is shown with the client device receiving the indication from the cloud environment(s) and/or the vulnerability repository, other examples may include an intermediary system (e.g., one or more intermediary devices) that receives and processes information from the cloud environment(s) and/or the vulnerability repository. Accordingly, the client device may receive the indication of the set of security vulnerabilities from the intermediary system. Additionally, or alternatively, the intermediary system may derive information (e.g., determining due dates based on a set of priorities, associated with the set of security vulnerabilities, received from the cloud environment(s) and/or the vulnerability repository) and/or apply machine learning models to generate derived information (e.g., identifying possible remediations for the set of security vulnerabilities). Accordingly, the client device may receive the derived information from the intermediary system.

As shown by reference number 110, the client device may determine a set of tickets to open for the set of security vulnerabilities. For example, the client device may filter duplicates out of the set of security vulnerabilities in order to ensure that the set of tickets does not have more than one ticket per security vulnerability. Duplicates may be caused by multiple systems reporting a same security vulnerability (e.g., both the cloud environment(s) and the vulnerability repository) and/or by a glitch in reporting. The client device may detect two security vulnerabilities as a duplicate based on both security vulnerabilities being associated with a same title and a same cloud-based application.

The client device may additionally perform aggregation of security vulnerabilities to reduce a quantity of tickets that are opened. In some implementations, the client device may aggregate two or more security vulnerabilities, in the set of security vulnerabilities, that share a cloud environment, into a single ticket in the set of tickets. For example, the client device may aggregate security vulnerabilities by environment for security vulnerabilities that are related to cloud storages (e.g., Amazon® Machine Image (AMI) appliances). The single ticket may thus indicate a quantity of the two or more security vulnerabilities (e.g., the client device may indicate the quantity in a command to open the set of tickets, as described below). Additionally, or alternatively, the client device may aggregate two or more security vulnerabilities, in the set of security vulnerabilities, that affect a plurality of cloud instances, into a single ticket in the set of tickets. For example, the client device may aggregate security vulnerabilities across instances for security vulnerabilities that are related to infrastructure (and are unrelated to AMI appliances). The single ticket may thus include a list of the plurality of cloud instances (e.g., the client device may include the list in a command to open the set of tickets, as described below). Additionally, or alternatively, the client device may aggregate two or more security vulnerabilities, in the set of security vulnerabilities, that affect a plurality of containers, into a single ticket in the set of tickets. For example, the client device may aggregate security vulnerabilities across containers for security vulnerabilities that are related to containers (and are unrelated to AMI appliances). The single ticket may thus include a list of the plurality of containers (e.g., the client device may include the list in a command to open the set of tickets, as described below). Another example includes the client device aggregating two or more security vulnerabilities, in the set of security vulnerabilities, that affect a plurality of code repositories, into a single ticket in the set of tickets. For example, the client device may aggregate security vulnerabilities across containers for security vulnerabilities that are related to whitesource findings (and thus affect Github® repositories and/or other types of code repositories). The client device may additionally aggregate security vulnerabilities across instances for security vulnerabilities that are related to configuration compliance (e.g., based on compliance activities).

As shown in FIG. 1B and by reference number 115, the vulnerability repository may transmit, and the client device may receive, an indication of a solution associated with a security vulnerability in the set (e.g., at least one security vulnerability). The ticket (e.g., at least one ticket) corresponding to the security vulnerability may thus indicate the solution (e.g., the client device may indicate the solution in a command to open the set of tickets, as described below).

In some implementations, the client device may transmit, and the vulnerability repository may receive, a request for any solutions associated with the set of security vulnerabilities. For example, the request may include an HTTP request and/or an API call, among other examples. The request may include (e.g., in a header and/or as an argument) an indication of the set of security vulnerabilities for which the client device is requesting solutions. Accordingly, the vulnerability repository may transmit the indication in response to the request. The client device may transmit the request according to a schedule (e.g., once per hour or once per day, among other examples) and/or in response to a command to transmit the request. For example, a user device may transmit, and the client device may receive, the command, such that the client device transmits the request in response to the command.

Although the example 100 is shown with the indication of the solution as separate from the indication of the set of security vulnerabilities, other examples may include the vulnerability repository providing the indication of the solution with the indication of the set of security vulnerabilities. For example, the vulnerability repository may store security vulnerability indications in association with possible solutions and thus may provide, to the client device, the indication of the set of security vulnerabilities along with an indication of any associated possible solutions.

Although the example 100 is shown with the client device receiving the indication from the vulnerability repository, other examples may include an intermediary system (e.g., one or more intermediary devices) that receives and processes information from the cloud environment(s) and/or the vulnerability repository. Accordingly, the client device may receive the indication of the solution from the intermediary system. In some implementations, the intermediate system may apply machine learning models to generate the indication of the solution.

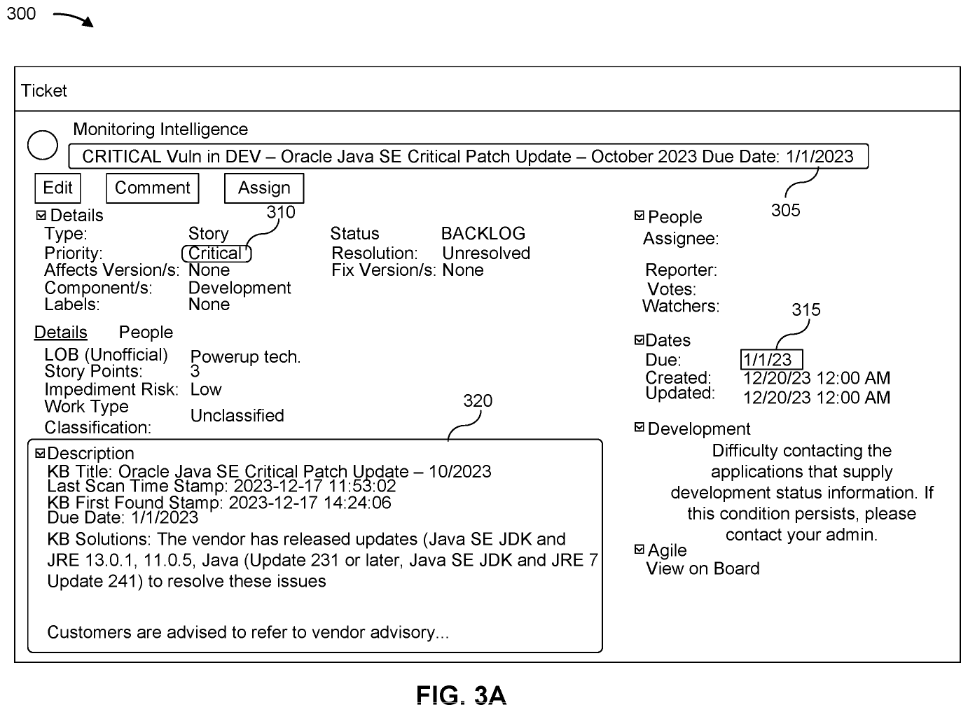

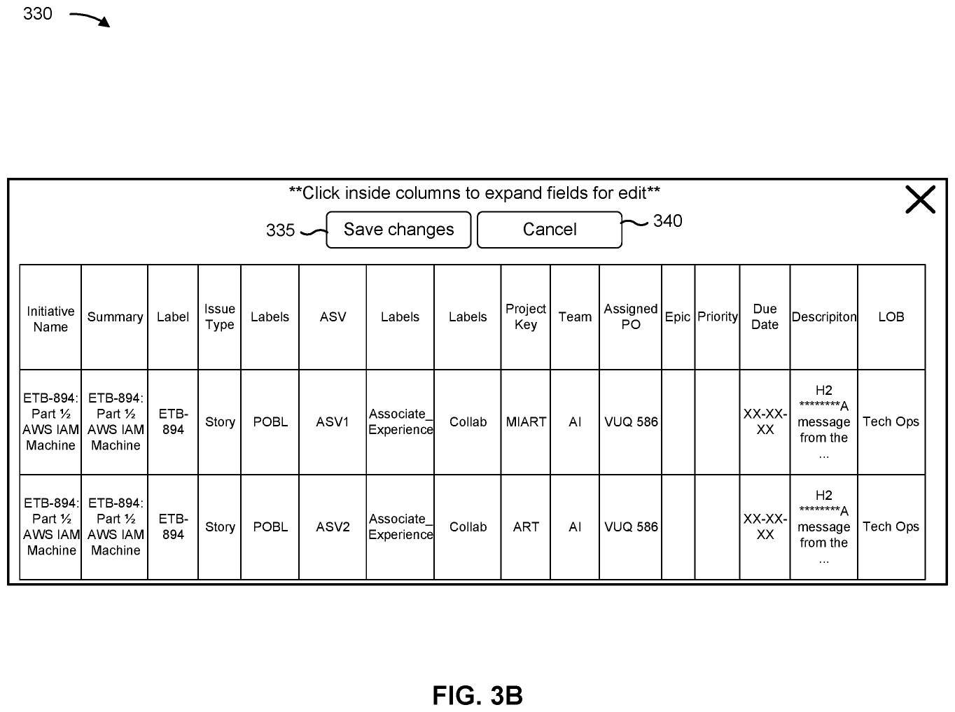

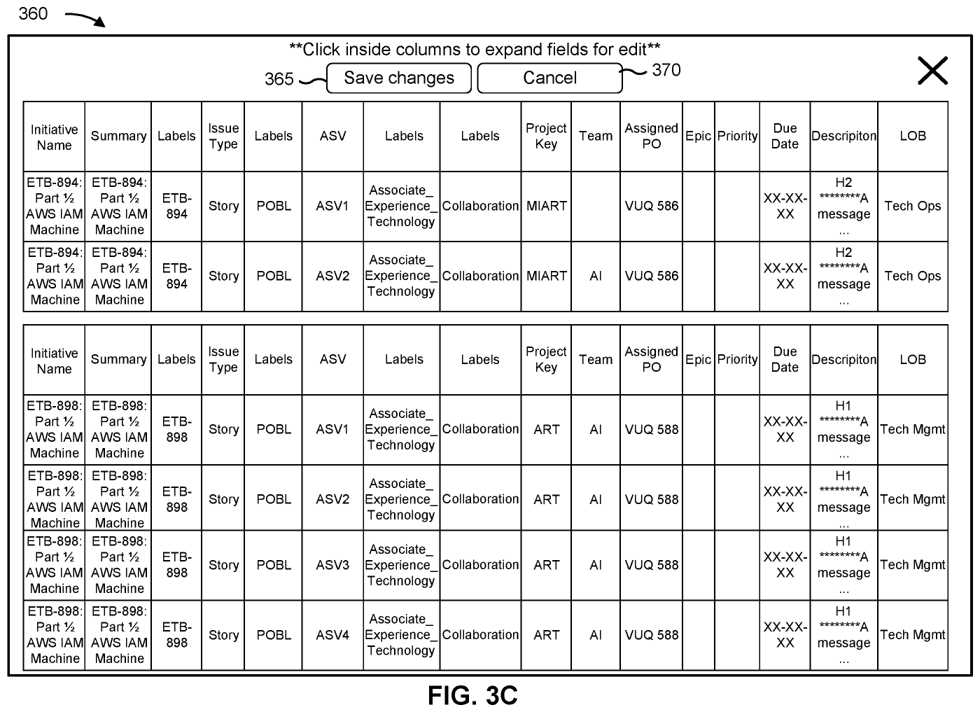

As shown by reference number 120, the client device may determine ticket content for the set of tickets. The ticket content may include titles, priorities, and/or due dates, as described below in connection with FIG. 3A. In one example, the indication of the set of security vulnerabilities may indicate the priorities and/or the due dates. Additionally, or alternatively, the client device may determine the due dates based on the priorities or may determine the priorities based on the due dates. Additionally, or alternatively, the client device may determine the due dates using a data structure that maps identifiers of security vulnerabilities (e.g., names or other alphanumeric identifiers) to due dates and/or may determine the priorities using a data structure that maps identifiers of security vulnerabilities (e.g., names or other alphanumeric identifiers) to priorities.

In some implementations, the client device may extract a set of titles that were included in the indication of the set of security vulnerabilities and include the set of titles in the command to open the set of tickets, as described below, such that each ticket in the set of tickets includes a title from the set of titles. Additionally, or alternatively, the client device may generate the set of titles. In one example, the client device may supplement a title that was included in the indication of the set of security vulnerabilities with a priority and/or a due date (e.g., resulting in a title as shown in FIG. 3A). In another example, the client device may determine the set of titles using a data structure that maps identifiers of security vulnerabilities (e.g., numeric identities (IDs) or other types of non-string identifiers) to titles (e.g., stored as strings).

As shown by reference number 125, the client device may transmit, and the ticket system may receive, a command to open the set of tickets. The command may be an HTTP request and/or an API call, among other examples. The command may include the set of titles, as described above. Additionally, or alternatively, the command may include the priority and the due date for each ticket, as described above. The command may additionally indicate a solution associated with a security vulnerability in the set of security vulnerabilities (e.g., as described above and as shown in FIG. 3A). In some implementations, the command further indicates a most recent scan time (e.g., as shown in FIG. 3A) associated with each security vulnerability.

In some implementations, the client device may identify a set of users (e.g., at least one user) associated with the set of security vulnerabilities. For example, the client device may use a data structure that maps identifiers of users (e.g., names, usernames, and/or email addresses, among other examples) to identifiers of cloud-based applications (that are associated with the set of security vulnerabilities). The command to open the set of tickets may thus include a set of identifiers (e.g., a name, a username, and/or an email address, among other examples) corresponding to the set of users identified by the client device.

Therefore, the ticket system may notify the set of users about the set of tickets. In some implementations, the ticket system may identify a set of devices associated with the set of users. For example, a data structure may map identifiers of users (e.g., names, usernames, and/or email addresses, among other examples) to identifiers of devices (e.g., machine names, Internet protocol (IP) addresses, and/or medium access control (MAC) addresses, among other examples). Therefore, the ticket system may transmit notifications to the set of devices. Alternatively, the ticket system may identify a set of email addresses and/or telephone numbers associated with the set of users, such that the notifications are included in email messages and/or text messages. The ticket system thus automatically communicates the security vulnerabilities to the set of users. The set of tickets may also indicate suggested remediations (e.g., the solution indicated to the client device, as described above). As a result, the set of users are more likely to perform remediation, which improves security.

The client device may transmit the command to open the set of tickets whenever new security vulnerabilities are detected (e.g., in response to receiving the indication described in connection with reference numbers 105a and 105b). Alternatively, the client device may transmit the command to open the set of tickets according to a schedule (e.g., at least one schedule). For example, the client device may transmit the command to open the set of tickets once per month, biweekly, once per week, daily, or hourly, among other examples. Accordingly, the client device aggregates the set of security vulnerabilities over a period of time and transmits the command for the set of tickets after the period of time expires.

In some implementations, the client device may use different schedules for different types of security vulnerabilities. Accordingly, the client device may transmit a first command to open a first portion of the set of tickets (e.g., corresponding to security vulnerabilities that are related to cloud storages) according to a first schedule (e.g., biweekly) and may transmit a second command to open a second portion of the set of tickets (e.g., corresponding to security vulnerabilities that are related to infrastructure or related to containers) according to a second schedule that is different from the first schedule (e.g., daily).

As shown in FIG. 1C and by reference number 130a, the client device may monitor to determine that a security vulnerability (e.g., at least one security vulnerability), in the set of security vulnerabilities, has been resolved. As shown in FIG. 1C, the client device may communicate with the cloud environment(s) to monitor for resolution of security vulnerabilities. In one example, the client device may transmit requests (e.g., periodically) to the cloud environment(s) for statuses associated with cloud-based applications (that are associated with the set of security vulnerabilities) and may determine that the security vulnerability has been resolved based on one of the statuses (e.g., at least one of the statuses). In another example, the cloud environment(s) may monitor the cloud-based applications and may transmit an indication that the security vulnerability has been resolved when the cloud environment(s) determines that the security vulnerability has been resolved (e.g., based on a status associated with at least one of the cloud-based applications).

Additionally, or alternatively, as shown by reference number 130b, the vulnerability repository may transmit, and the client device may receive, an indication that a security vulnerability (e.g., at least one security vulnerability), in the set of security vulnerabilities, has been resolved. In some implementations, the client device may transmit, and the vulnerability repository may receive, a request for statuses associated with the set of security vulnerabilities. For example, the request may include an HTTP request and/or an API call, among other examples. The request may include (e.g., in a header and/or as an argument) an indication of the set of security vulnerabilities for which the client device is requesting statuses. Accordingly, the vulnerability repository may transmit the indication that the security vulnerability has been resolved in response to the request. The client device may transmit the request according to a schedule (e.g., once per hour or once per day, among other examples) and/or in response to a command to transmit the request. For example, a user device may transmit, and the client device may receive, the command, such that the client device transmits the request in response to the command.

Although the example 100 is shown with the client device receiving the indication from the vulnerability repository, other examples may include an intermediary system (e.g., one or more intermediary devices) that receives and processes information from the cloud environment(s) and/or the vulnerability repository. Accordingly, the client device may receive the indication that the security vulnerability has been resolved from the intermediary system. In some implementations, the intermediate system may monitor (e.g., with the cloud environment(s)) to determine that the security vulnerability has been resolved.

As shown by reference number 135, the client device may transmit, and the ticket system may receive, a command to close a ticket (e.g., at least one ticket), in the set of tickets, corresponding to the security vulnerability that has been resolved. Therefore, the client device automatically conserves memory overhead at the ticket system. Additionally, the client device conserves power, processing resources, and network overhead that otherwise would have been used by a user device in communicating with the ticket system to close the ticket.

By using techniques as described in connection with FIGS. 1A-1C, the client device automatically generates the set of tickets, using the ticket system, based on the set of security vulnerabilities that were detected. Additionally, the client device automatically closes a ticket based on detecting a resolved security vulnerability, which conserves power, processing resources, and network resources that otherwise would have been spent maintaining that ticket even after resolution of the security vulnerability.

As indicated above, FIGS. 1A-1C are provided as an example. Other examples may differ from what is described with regard to FIGS. 1A-1C.

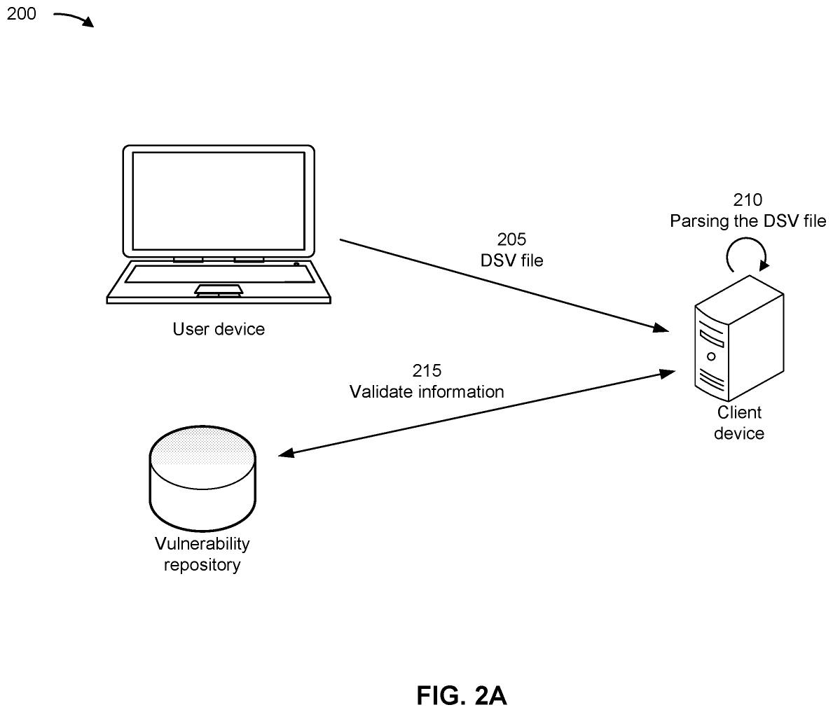

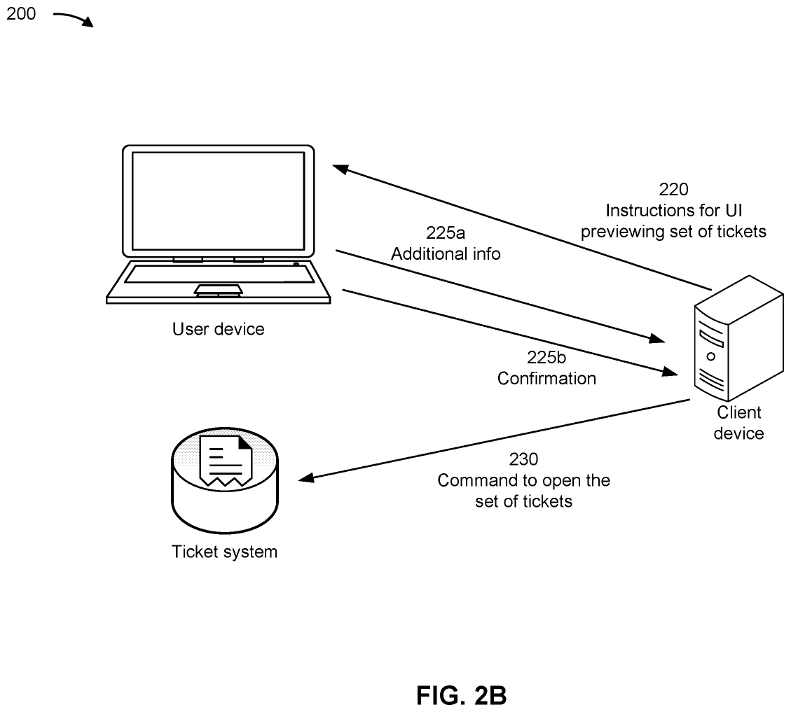

FIGS. 2A-2B are diagrams of an example 200 associated with security vulnerability tracking and resolution. As shown in FIGS. 2A-2B, example 200 includes a client device, a user device, a vulnerability repository, and a ticket system. These devices are described in more detail in connection with FIGS. 4 and 5.

As shown in FIG. 2A and by reference number 205, the user device may transmit, and the client device may receive, a delimiter-separated values (DSV) file (e.g., at least one DSV file). In some implementations, the DSV file may include a CSV file. The user device may receive input from a user (e.g., via an input component of the user device) that triggers the user device to upload the DSV file to the client device. In some implementations, the input may include an interaction with a user interface (UI) that is output by the user device (e.g., via an output component of the user device).

Although the example 200 is shown with the user device transmitting the DSV file directly, other examples may include the user device indicating a location associated with the DSV file to the client device. The location may include a filename, a file path, an alphanumeric identifier associated with the DSV file, and/or another type of identifier that indicates where the DSV file is stored. Accordingly, the client device may transmit a request for the DSV file that indicates the location. In some implementations, the DSV file may be stored locally (e.g., included in a cache or another type of memory controlled by the client device). Accordingly, the request may include a read command transmitted to the memory. Alternatively, the DSV file may be stored at least partially separately (e.g., physically, logically, and/or virtually) from the client device. Accordingly, the request may include an HTTP request and/or an API call.

As shown by reference number 210, the client device may parse the DSV file to determine a plurality of projects indicated in the DSV file. For example, the client device may determine different project keys (e.g., as shown in FIG. 3B and FIG. 3C) and/or different epic names associated with different portions of the DSV file.

In some implementations, as shown by reference number 215, the client device may communicate with the vulnerability repository to validate information in the DSV file. For example, the client device may verify titles, due dates, priorities, possible solutions, and/or user identifiers that are indicated in the DSV file. The vulnerability repository may store identifiers of security vulnerabilities in association with titles (e.g., represented as strings), due dates (e.g., represented as amounts of time calculated from detection), priorities, possible solutions (e.g., represented as strings and/or hyperlinks), and/or user identifiers (e.g., names, usernames, email addresses, and/or phone numbers, among other examples). In some implementations, the vulnerability repository may receive information automatically (e.g., as output from one or more ASVs) and/or manually (e.g., entered by one or more administrators associated with cloud-based applications).

Additionally, or alternatively, the client device may communicate with the ticket system to validate information in the DSV file. For example, the client device may verify project keys, epics, and/or labels that are indicated in the DSV file. The client device may instruct the ticket system to create new project keys, epics, and/or labels based on the DSV file including new project keys, epics, and/or labels that have not been previously used.

As shown in FIG. 2B and by reference number 220, the client device may transmit, and the user device may receive, instructions for a UI previewing a set of tickets based on information in the DSV file and associated with the plurality of projects. The UI may be as described in connection with FIG. 3B or FIG. 3C. Accordingly, the UI may include a set of rows that correspond to the set of tickets. Additionally, the UI may include a plurality of columns associated with a plurality of fields included in each ticket. For example, one of the columns may indicate project keys and thus be associated with the plurality of projects. Similarly, one of the columns may indicate epics and thus be associated with the plurality of projects. The client device may populate (at least a portion of) the plurality of columns based on the information in the DSV file.

As shown by reference number 225a, the user device may transmit, and the client device may receive, additional information using the UI. For example, a user of the user device may interact with elements of the UI (e.g., text boxes) to provide the additional information and/or modify the information extracted from the DSV file and previewed in the UI. In some implementations, an input element of the UI may increase in size when the user selects the input element (in order to improve the user's experience with providing the additional information and/or modifying the information extracted from the DSV file). In one example, the user of the user device may fill in blank portions of columns to populate fields that were excluded from the DSV file (e.g., the “Epic” or “Priority” columns of FIGS. 3B and 3C). Additionally, or alternatively, the user of the user device may modify portions of columns to change information that was included in the DSV file (e.g., changing the “Due Date” or “Description” columns of FIGS. 3B and 3C, among other examples).

As shown by reference number 225b, the user device may transmit, and the client device may receive, a confirmation of the set of tickets. For example, the user of the user device may interact with a button of the UI (e.g., the button 335 of FIG. 3B or the button 365 of FIG. 3C) to trigger the user device to transmit the confirmation. Therefore, as shown by reference number 230, the client device may transmit, and the ticket system may receive, a command to open the set of tickets in response to the confirmation. The command to open the set of tickets may indicate, for each ticket, a user (e.g., at least one user) to assign to the ticket. Therefore, the ticket system may notify users about the set of tickets, as described above. In implementations where the user device provides additional information and/or modified information, as described above, the command to open the set of tickets may include the additional information and/or the modified information in combination with information from the DSV file.

By using techniques as described in connection with FIGS. 2A-2B, the client device generates the set of tickets, based on the DSV file, associated with the plurality of projects. As a result, power, processing resources, network resources, and memory overhead are all conserved that otherwise would have been wasted on separating the DSV file by project. Additionally, the user of the user device may provide additional information (or different information from that in the DSV file) with the UI before the set of tickets is opened. As a result, power, processing resources, and network resources are all conserved that otherwise would have been spent on adding information to (or modifying information in) the set of tickets after opening.

As indicated above, FIGS. 2A-2B are provided as an example. Other examples may differ from what is described with regard to FIGS. 2A-2B.

FIGS. 3A, 3B, and 3C are diagram of example UIs 300, 330, and 360, respectively, generated by systems and/or methods described herein. For example, the user device may output the example UI 300, the example UI 330, and/or the example UI 360 based on instructions from the client device. These devices are described in more detail in connection with FIGS. 4 and 5.

As shown in FIG. 3A, the example UI 300 may represent a ticket associated with a security vulnerability (and opened by the client device, as described in connection with FIGS. 1A-1C). The example UI 300 includes a title 305 associated with the ticket. The title 305 may indicate a priority (“CRITICAL” in FIG. 3A), a name associated with the security vulnerability (“Oracle Java SE Critical Patch Update-October 2023” in FIG. 3A), and a due date (“Jan. 1, 2023” in FIG. 3A). The example UI 300 further indicates a priority 310 and a due date 315 associated with the ticket. The example UI 300 may also indicate a solution 320 for the security vulnerability. In some implementations, an area of the example UI 300 with the solution 320 (e.g., a box) may also indicate a quantity of security vulnerabilities associated with a same cloud environment and aggregated into the ticket, a list of cloud instances affected by the security vulnerability, or a list of containers affected by the security vulnerability, as described in connection with FIG. 1A.

As shown in FIG. 3B, the example UI 330 may include rows that correspond to tickets. In FIG. 3B, a first row represents a ticket with a title “ETB-894: Part ½ AWS IAM Machine,” and a second row represents a ticket with the same title. Additionally, the example UI 330 may include columns that correspond to fields included in the tickets. In FIG. 3B, multiple columns are associated with labels for the tickets (e.g., “POBL,” “Associate_Experience,” and “Collab”). Additionally, one column indicates ASVs associated with the tickets (e.g., ASV1 and ASV2 in FIG. 3B), one column indicates projects associated with the tickets (e.g., “MIART” and “ART” in FIG. 3B), one column indicates users assigned to the tickets (e.g., “VUQ 586” in FIG. 3B), and one column indicates epics associated with the tickets. Additional columns are associated with priorities for the tickets, due dates for the tickets, and teams associated with the tickets (shown as “LOB” and “Team” in FIG. 3B). The example UI 330 may further include a button 335 (or another interactive element) that triggers the client device to transmit a command to open the tickets (e.g., as described in connection with FIG. 2B). A button 340 (or another interactive element) may trigger the client device to cancel creation of the tickets.

The example UI 360 of FIG. 3C is similar to the example UI 330 of FIG. 3B but includes additional rows and different variations of entries in columns. The example UI 360 may further include a button 365 (or another interactive element) that triggers the client device to transmit a command to open the tickets (e.g., as described in connection with FIG. 2B). A button 370 (or another interactive element) may trigger the client device to cancel creation of the tickets.

As indicated above, FIGS. 3A-3C are provided as examples. Other examples may differ from what is described with regard to FIGS. 3A-3C.

FIG. 4 is a diagram of an example environment 400 in which systems and/or methods described herein may be implemented. As shown in FIG. 4, environment 400 may include one or more cloud environments 401, which may include one or more elements of and/or may execute within a cloud computing system 402. The cloud computing system 402 may include one or more elements 403-412, as described in more detail below. As further shown in FIG. 4, environment 400 may include a network 420, a client device 430, a user device 440, a ticket system 450, and/or a vulnerability repository 460. Devices and/or elements of environment 400 may interconnect via wired connections and/or wireless connections.

The cloud computing system 402 may include computing hardware 403, a resource management component 404, a host operating system (OS) 405, and/or one or more virtual computing systems 406. The cloud computing system 402 may execute on, for example, an Amazon Web Services platform, a Microsoft Azure platform, or a Snowflake platform. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

The computing hardware 403 may include hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, and/or one or more networking components 409. Examples of a processor, a memory, and a networking component (e.g., a communication component) are described elsewhere herein.

The resource management component 404 may include a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 410. Additionally, or alternatively, the resource management component 404 may include a container manager, such as when the virtual computing systems 406 are containers 411. In some implementations, the resource management component 404 executes within and/or in coordination with a host operating system 405.

A virtual computing system 406 may include a virtual environment that enables cloud-based execution of operations and/or processes described herein using computing hardware 403. As shown, a virtual computing system 406 may include a virtual machine 410, a container 411, or a hybrid environment 412 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

Although the cloud environment(s) 401 may include one or more elements 403-412 of the cloud computing system 402, may execute within the cloud computing system 402, and/or may be hosted within the cloud computing system 402, in some implementations, the cloud environment(s) 401 may not be cloud-based (e.g., may be implemented outside of a cloud computing system) or may be partially cloud-based. For example, the cloud environment(s) 401 may include one or more devices that are not part of the cloud computing system 402, such as device 500 of FIG. 5, which may include a standalone server or another type of computing device. The cloud environment(s) 401 may perform one or more operations and/or processes described in more detail elsewhere herein.

The network 420 may include one or more wired and/or wireless networks. For example, the network 420 may include a cellular network, a public land mobile network (PLMN), a local area network (LAN), a wide area network (WAN), a private network, the Internet, and/or a combination of these or other types of networks. The network 420 enables communication among the devices of the environment 400.

The client device 430 may include one or more devices capable of receiving, generating, storing, processing, and/or providing information associated with security vulnerabilities, as described elsewhere herein. The client device 430 may include a communication device and/or a computing device. For example, the client device 430 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. The client device 430 may communicate with one or more other devices of environment 400, as described elsewhere herein.

The user device 440 may include one or more devices capable of receiving, generating, storing, processing, and/or providing information associated with DSV files, as described elsewhere herein. The user device 440 may include a communication device and/or a computing device. For example, the user device 440 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 440 may communicate with one or more other devices of environment 400, as described elsewhere herein.

The ticket system 450 may include one or more devices capable of receiving, generating, storing, processing, and/or providing information associated with tickets, as described elsewhere herein. The ticket system 450 may include a communication device and/or a computing device. For example, the ticket system 450 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ticket system 450 may include an issue tracking system, such as Jira or Bugzilla®, among other examples. The ticket system 450 may communicate with one or more other devices of environment 400, as described elsewhere herein.

The vulnerability repository 460 may include one or more devices capable of receiving, generating, storing, processing, and/or providing information associated with security vulnerabilities, as described elsewhere herein. The vulnerability repository 460 may include a communication device and/or a computing device. For example, the vulnerability repository 460 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The vulnerability repository 460 may communicate with one or more other devices of environment 400, as described elsewhere herein.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the environment 400 may perform one or more functions described as being performed by another set of devices of the environment 400.

FIG. 5 is a diagram of example components of a device 500 associated with security vulnerability tracking and resolution. The device 500 may correspond to a client device 430, a user device 440, a ticket system 450, and/or a vulnerability repository 460. In some implementations, a client device 430, a user device 440, a ticket system 450, and/or a vulnerability repository 460 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

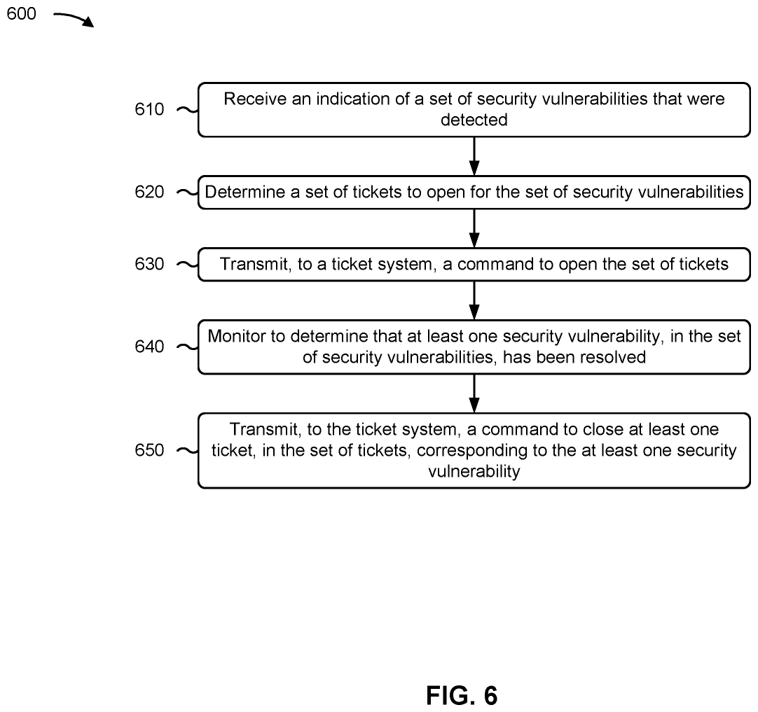

FIG. 6 is a flowchart of an example process 600 associated with security vulnerability tracking and resolution. In some implementations, one or more process blocks of FIG. 6 may be performed by a client device 430. In some implementations, one or more process blocks of FIG. 6 may be performed by another device or a group of devices separate from or including the client device 430, such as one or more cloud environments 401, a user device 440, a ticket system 450, and/or a vulnerability repository 460. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving an indication of a set of security vulnerabilities that were detected (block 610). For example, the client device 430 (e.g., using processor 520, memory 530, input component 540, and/or communication component 560) may receive an indication of a set of security vulnerabilities that were detected, as described above in connection with reference number 105a and reference number 105b of FIG. 1A. As an example, the client device 430 may receive the indication of the set of security vulnerabilities from one or more cloud environments, a vulnerability repository, and/or an intermediate system.

As further shown in FIG. 6, process 600 may include determining a set of tickets to open for the set of security vulnerabilities (block 620). For example, the client device 430 (e.g., using processor 520 and/or memory 530) may determine a set of tickets to open for the set of security vulnerabilities, as described above in connection with reference number 110 of FIG. 1A. As an example, the client device 430 may filter duplicates out of the set of security vulnerabilities in order to ensure that the set of tickets does not have more than one ticket per security vulnerability. Additionally, or alternatively, the client device 430 may perform aggregation within the set of security vulnerabilities to reduce a quantity of tickets in the set of tickets.

As further shown in FIG. 6, process 600 may include transmitting, to a ticket system, a command to open the set of tickets (block 630). For example, the client device 430 (e.g., using processor 520, memory 530, and/or communication component 560) may transmit, to a ticket system, a command to open the set of tickets, as described above in connection with reference number 125 of FIG. 1B. As an example, the command may include a set of titles associated with the set of security vulnerabilities, may indicate a priority and a due date for each ticket, may indicate a solution associated with a security vulnerability in the set of security vulnerabilities, and/or may indicate a most recent scan time associated with each security vulnerability.

As further shown in FIG. 6, process 600 may include monitoring to determine that at least one security vulnerability, in the set of security vulnerabilities, has been resolved (block 640). For example, the client device 430 (e.g., using processor 520 and/or memory 530) may monitor to determine that at least one security vulnerability, in the set of security vulnerabilities, has been resolved, as described above in connection with reference number 130a of FIG. 1C. As an example, client device 430 may communicate with one or more cloud environments to monitor for resolution of security vulnerabilities.

As further shown in FIG. 6, process 600 may include transmitting, to the ticket system, a command to close at least one ticket, in the set of tickets, corresponding to the at least one security vulnerability (block 650). For example, the client device 430 (e.g., using processor 520, memory 530, and/or communication component 560) may transmit, to the ticket system, a command to close at least one ticket, in the set of tickets, corresponding to the at least one security vulnerability, as described above in connection with reference number 135 of FIG. 1C. As a result, the client device 430 automatically conserves memory overhead at the ticket system. Additionally, the client device 430 conserves power, processing resources, and network overhead that otherwise would have been used by a user device in communicating with the ticket system to close the ticket.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1C, FIGS. 2A-2B, and/or FIGS. 3A-3C. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for automatically creating and closing tickets for security vulnerabilities, the system comprising:
one or more memories; and
one or more processors, communicatively coupled to the one or more memories, configured to:
receive an indication of a set of security vulnerabilities that were detected;
determine a set of tickets to open for the set of security vulnerabilities;
determine a priority and a due date for each ticket in the set of tickets;
transmit, to a ticket system, a command to open the set of tickets including the priority and the due date for each ticket;
receive an indication that at least one security vulnerability, in the set of security vulnerabilities, has been resolved; and
transmit, to the ticket system, a command to close at least one ticket, in the set of tickets, corresponding to the at least one security vulnerability.

2. The system of claim 1, wherein the one or more processors, to determine the set of tickets, are configured to:
aggregate two or more security vulnerabilities, in the set of security vulnerabilities, that share a cloud environment, into a single ticket in the set of tickets,
wherein the single ticket indicates a quantity of the two or more security vulnerabilities.

3. The system of claim 1, wherein the one or more processors, to determine the set of tickets, are configured to:
aggregate two or more security vulnerabilities, in the set of security vulnerabilities, that affect a plurality of cloud instances, into a single ticket in the set of tickets,
wherein the single ticket includes a list of the plurality of cloud instances.

4. The system of claim 1, wherein the one or more processors, to determine the set of tickets, are configured to:
aggregate two or more security vulnerabilities, in the set of security vulnerabilities, that affect a plurality of containers, into a single ticket in the set of tickets,
wherein the single ticket includes a list of the plurality of containers.

5. The system of claim 1, wherein the at least one ticket indicates a most recent scan time associated with the at least one security vulnerability.

6. The system of claim 1, wherein the one or more processors are configured to:
receive, from a vulnerability repository, an indication of a solution associated with the at least one security vulnerability,
wherein the at least one ticket, corresponding to the at least one security vulnerability, indicates the solution.

7. The system of claim 1, wherein the one or more processors, to transmit the command to open the set of tickets, are configured to:
transmit the command according to at least one schedule.

8. A method of creating tickets for security vulnerabilities from delimited values, comprising:
receiving, from a user device, at least one delimiter-separated values (DSV) file;
parsing, by a client device, the at least one DSV file to determine a plurality of projects indicated in the at least one DSV file;
transmitting, to the user device, instructions for a user interface (UI) previewing a set of tickets based on information in the at least one DSV file and associated with the plurality of projects;
receiving, from the user device, a confirmation of the set of tickets; and
transmitting, to a ticket system, a command to open the set of tickets in response to the confirmation.

9. The method of claim Error! Reference source not found., wherein the at least one DSV file includes a comma-separated values file.

10. The method of claim Error! Reference source not found., wherein the UI includes a set of rows that correspond to the set of tickets, and the UI includes a plurality of columns associated with a plurality of fields included in each ticket.

11. The method of claim 10, wherein one column, in the plurality of columns, is associated with the plurality of projects.

12. The method of claim 10, further comprising:
populating, by the client device, at least a portion of the plurality of columns based on the information in the at least one DSV file.

13. The method of claim Error! Reference source not found., further comprising:
receiving, from the user device, additional information using the UI,
wherein the command to open the set of tickets includes the information in the at least one DSV file and the additional information.

14. The method of claim Error! Reference source not found., wherein the command to open the set of tickets indicates, for each ticket, at least one user to assign to the ticket.

15. A non-transitory computer-readable medium storing a set of instructions for creating and closing tickets for security vulnerabilities, the set of instructions comprising:
one or more instructions that, when executed by one or more processors of a device, cause the device to:
receive an indication of a set of security vulnerabilities that were detected;
determine a set of tickets to open for the set of security vulnerabilities;
transmit, to a ticket system, a command to open the set of tickets;
monitor to determine that at least one security vulnerability, in the set of security vulnerabilities, has been resolved; and
transmit, to the ticket system, a command to close at least one ticket, in the set of tickets, corresponding to the at least one security vulnerability.

16. The non-transitory computer-readable medium of claim Error! Reference source not found., wherein the indication further includes a set of titles, and each ticket in the set of tickets includes a title from the set of titles.

17. The non-transitory computer-readable medium of claim Error! Reference source not found., wherein the one or more instructions, when executed by the one or more processors, cause the device to:
determine a set of due dates for the set of tickets,
wherein the command to open the set of tickets indicates the set of due dates.

18. The non-transitory computer-readable medium of claim Error! Reference source not found., wherein the one or more instructions, when executed by the one or more processors, cause the device to:
determine a set of priorities for the set of tickets,
wherein the command to open the set of tickets indicates the set of priorities.

19. The non-transitory computer-readable medium of claim Error! Reference source not found., wherein the one or more instructions, when executed by the one or more processors, cause the device to:
generate a set of titles for the set of tickets,
wherein the command to open the set of tickets indicates the set of titles.

20. The non-transitory computer-readable medium of claim Error! Reference source not found., wherein the one or more instructions, that cause the device to transmit the command to open the set of tickets, cause the device to:
transmit a first command to open a first portion of the set of tickets according to a first schedule; and
transmit a second command to open a second portion of the set of tickets according to a second schedule that is different from the first schedule.
